(19) United States
(12) Patent Application Publication
(10) Pub. No.: US 2007/0152969 A1
(43) Pub. Date: Jul. 5, 2007

(54) Operating structure of electric pointing device

(75) Inventor: Kuan-Nan Chou, Sijhih City (TW)

Correspondence Address: BIRCH STEWART KOLASCH & BIRCH, PO BOX 747, FALLS CHURCH, VA, 22040-0747, US

(73) Assignee: Behavior Tech Computer Corp.

(21) Appl. No.: 11/580,831

(22) Filed: Oct. 16, 2006

(30) Foreign Application Priority Data
Jan. 2, 2006 (TW) 95100059

(51) Int. Cl. G09G 5/08

(52) U.S. Cl. 345/163

(57) ABSTRACT

An operating structure of an electric pointing device is provided. The operating structure includes a multi-directive movable part, comprising a manual operating area and at least a button. The manual operating area includes a curved surface contacted and moved by a palm of a hand, wherein the buttons are installed on the curved surface, such that the locations of the buttons are easy for fingers of the hand to touch and operate the buttons accordingly. A knob is installed on the curved surface for leaning against a part of the hand between a thumb and an index finger. In accordance, a relative position between the hand operating the curved surface and the fingers operating the buttons remains unchanged when the multi-directive movable part is moved.

### RELATED APPLICATIONS

The present application is based on, and claims priority from, Taiwan Application Serial Number 95100059, filed on Jan. 02 2006, the disclosure of which is hereby incorporated by reference herein in its entirety.

### BACKGROUND

1. Field of Invention

The present invention relates to an operating structure of an electric pointing device.

2. Description of Related Art

An electric pointing device in the prior art, i.e. a conventional computer mouse, is shown in FIG. 1A. As illustrated in FIG. 1A, there are usually only a left key, a right key, and a scroll wheel included in the operating interface of the conventional computer mouse. However, in the trend of integrating multi-functions for nowadays, there are even more functional keys and buttons are needed in the operating interface of the computer mouse. The functional keys of the operating interface in the prior art are no more enough for demands. While there are as many functional keys as needed disposed on the operating interface simultaneously, it is necessary to consider if the user can easily and comfortably control the functional keys. However, it is still a bottleneck for the conventional technologies.

FIG. 1B illustrates another electric pointing device in the prior art, a conventional joystick. The operating interface design of the conventional joystick is complicated and inconvenient for the user since the user needs to move fingers back and forth among different keys. Hence the mood to joy is depressed accordingly.

FIG. 1C illustrates still another electric pointing device in the prior art, a conventional game wheel, especially for a car racing simulation game. As illustrated in FIG. 1C, not only the size of the conventional game wheel is huge, but the user also needs to hold the wheel by two hands for a better sense of control. This kind of design is inconvenience for users to carry, and is laborious to operate.

For the forgoing reasons, there is a need for a novel operating structure of an electric pointing device that improves the sense of control when operating said electric pointing device for user.

### SUMMARY

It is therefore an aspect of the present invention to provide an operating structure of an electric pointing device, especially an operating structure that is applied to various kinds of electric pointing devices, such like computer mice, game wheels, etc.

It is another aspect of the present invention to provide an operating structure of an electric pointing device with multiple functional keys assembled thereon, while the user can still have a good sense of control.

In accordance with the foregoing and other aspect of the present invention, an operating structure of an electric pointing device is provided that includes a multi-directive movable part, comprising a manual operating area and at least a button. The manual operating area comprises a curved surface, contacted and moved by a palm of a hand, wherein the buttons are installed on the curved surface, such that the locations of the buttons are easy for fingers of the hand to touch and operate the buttons accordingly. A knob is installed on the curved surface for leaning against a part of the hand between a thumb and an index finger. In accordance, a relative position between the hand operating the curved surface and the fingers operating the buttons remains unchanged when the multi-directive movable part is moved.

This and other features, aspects, and advantages of the present invention will become better understood with reference to the following description, figures, and appended claims.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A is a diagram of an electric pointing device in the prior art;

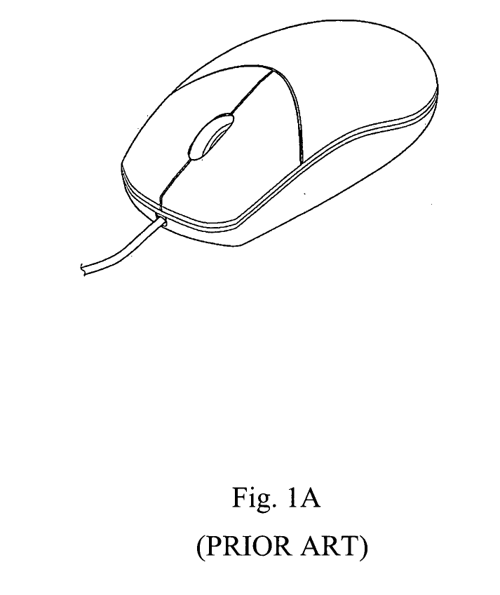

FIG. 1B is a diagram of another electric pointing device in the prior art;

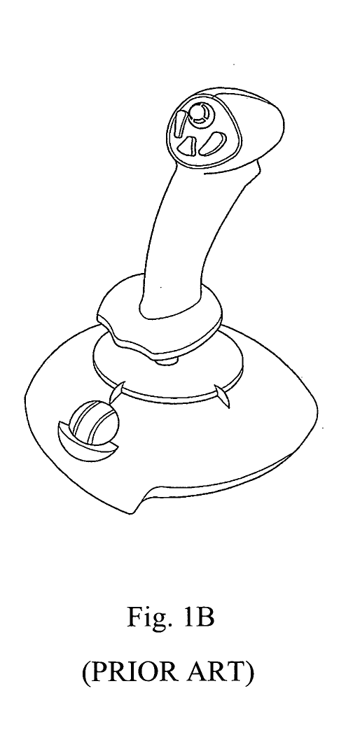

FIG. 1C is a diagram of still another electric pointing device in the prior art;

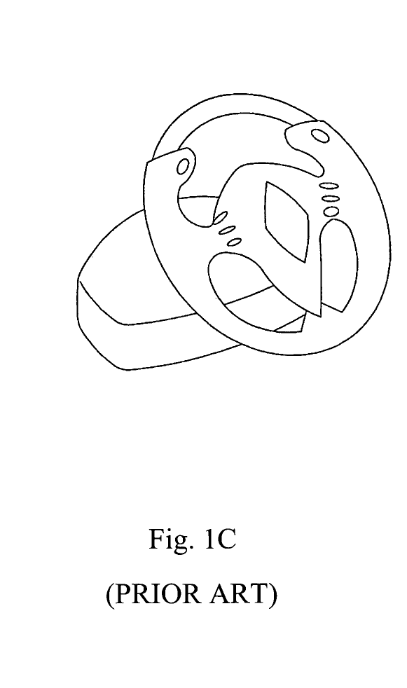

FIG. 2A is a diagram of an operating structure applied to an electric pointing device according to an embodiment of this invention;

FIG. 2B is a top view of the operating structure in FIG. 2A;

FIG. 2C is a side elevation of the operating structure in FIG. 2A;

FIG. 2D is another side elevation of the operating structure in FIG. 2A;

FIG. 2E is still another side elevation of the operating structure in FIG. 2A; and

FIG. 3 is a diagram of an operating structure applied to an electric pointing device according to a variation of the present invention.

### DESCRIPTION OF THE PREFERRED EMBODIMENTS

An operating structure of an electric pointing device is herein introduced to solve the problems in the prior art.

Reference will now be made in detail to the present preferred embodiments of the invention, examples of which are illustrated in the accompanying drawings. Wherever possible, the same reference numbers are used in the drawings and the description to refer to the same or like parts.

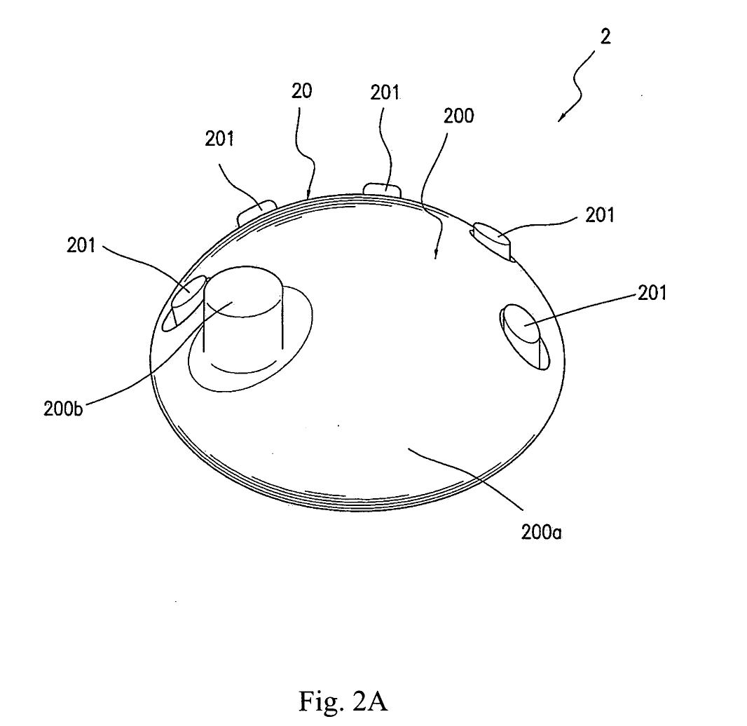

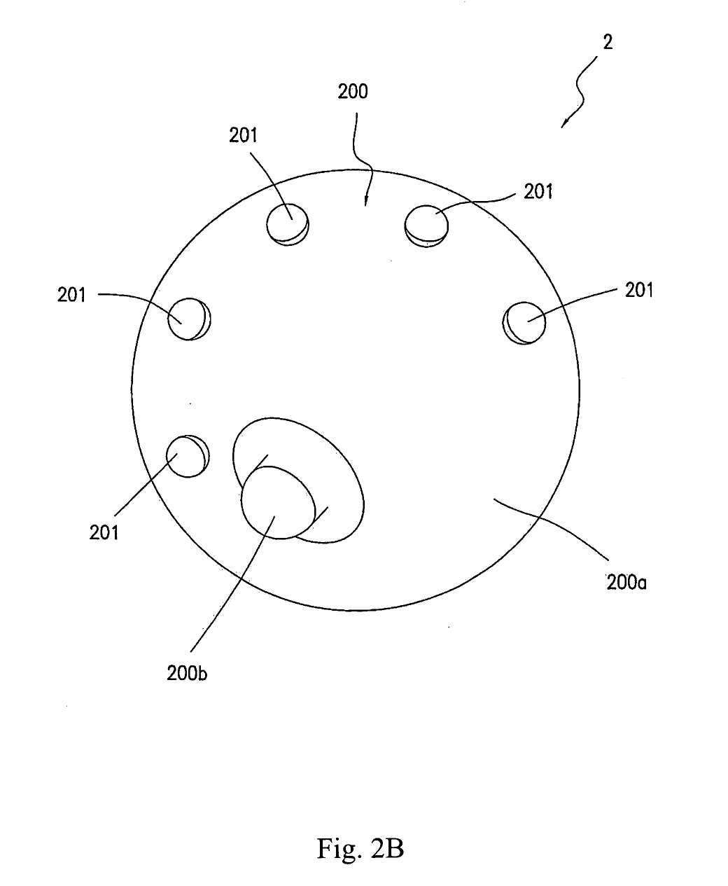

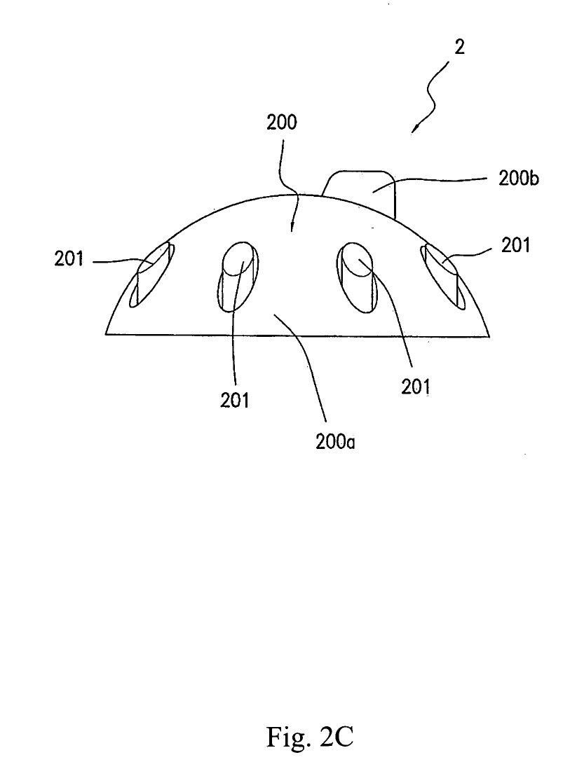

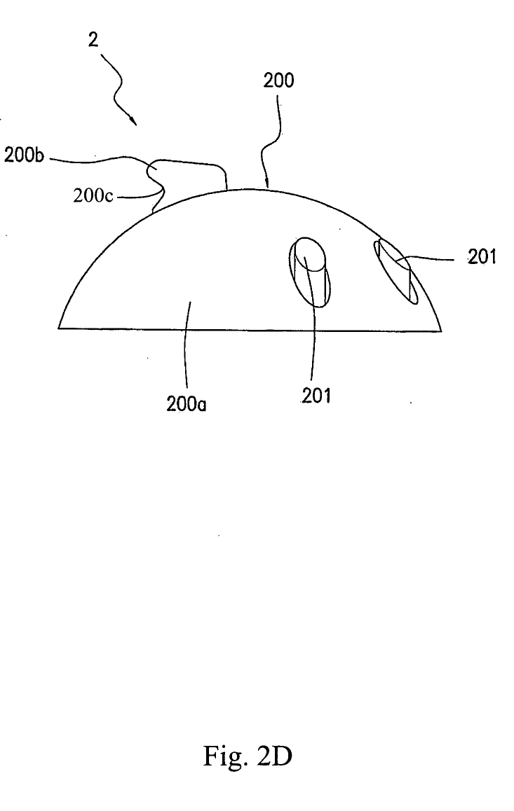

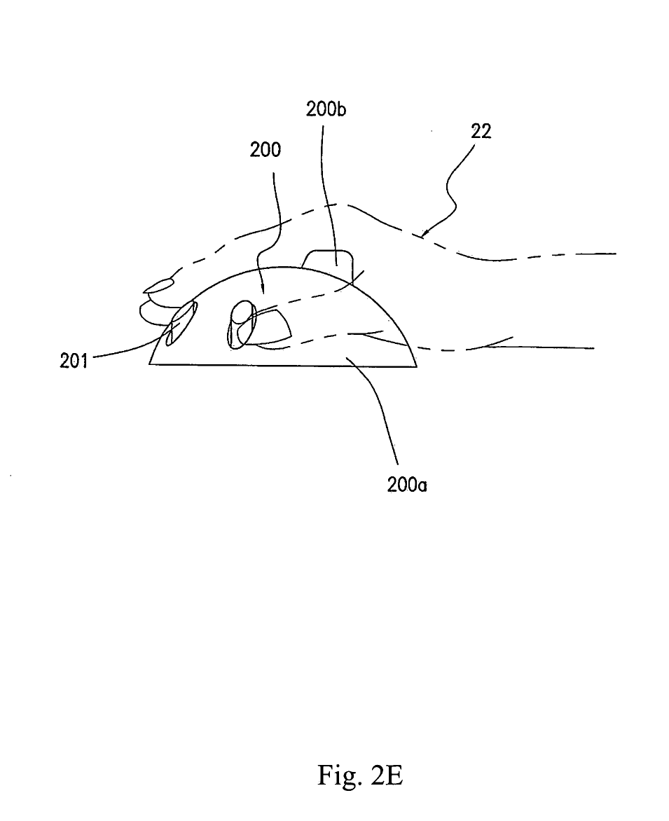

FIG. 2A illustrates an embodiment of the operating structure of an electric pointing device of the present invention. Referring to FIG. 2A, an operating structure (2) is shown, applied to possibly a computer mouse, a game wheel or some other electric pointing device. The multi-directive movable part (20) includes a manual operating area (200) and at least a button (201). Usually, if the operating structure (2) is related to a computer mouse or a game wheel, the multi-directive movable part (20) would be a circle disk structure. In addition, if the operating structure (2) is specifically applied to a game wheel, the multi-directive movable part (20) may be a sphere structure. Only an upper half of the sphere structure is displayed in FIG. 2A.

FIG. 2B is a top view of the operating structure in FIG. 2A. It is easily observed in FIG. 2B that each of the buttons (201) is corresponding to each finger of the user, respectively.

FIG. 2C is a side elevation of the operating structure in FIG. 2A. Referring to FIG. 2C, the manual operating area (200) includes a curved surface (200a) for the palm of the user to touch, and to operate and move the curved surface (200a) manually. The buttons (201) are assembled on the curved surface (200a), and the location of each button (201) is just for each of the fingers of the user to touch spontaneously, and to control the button (201) simultaneously. Hence, the buttons (201) should be installed within an area where the fingers of the user can readily reach. Besides, the manual operating area (200) further includes a knob (200b), installed on the curved surface (200a).

FIG. 2D is another side elevation of the operating structure in FIG. 2A. Please refer to FIG. 2D. The curved surface (200a) is a surface of a circle shape. The angle of a tangent plane of the top of each button (200a) is identical to the angle of a tangent plane of the curved surface (200a). Further, it is shown in FIG. 2D that the knob (200b) includes a concave portion 200c for the part of the hand between the thumb and the index finger to be close tight to fit with.

FIG. 2E is still another side elevation of the operating structure in FIG. 2A. Referring to FIG. 2E, the knob (200b) is for the part of the hand (22) between the thumb and the index finger to be close against. Hence the relative position between the hand operating the curved surface and the fingers (220) operating the buttons (201) are maintained when multi-directive movable part is operated to any angle manually.

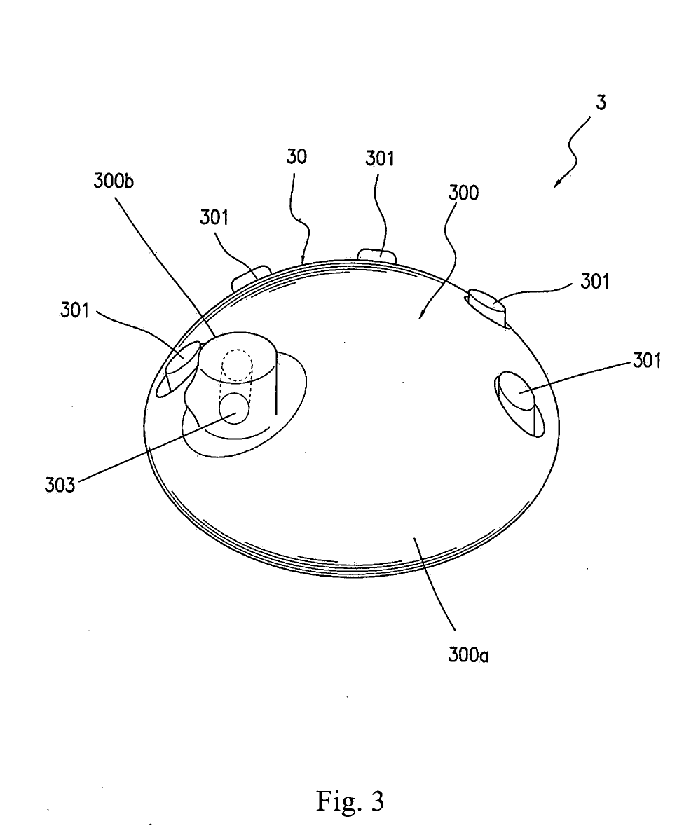

Illustrated in FIG. 3 is a variation of the operating structure of an electric pointing device of the present invention. Referring to FIG. 3, the multi-directive movable part (30) of the operating structure (3) includes a manual operating area (300) and buttons (301). The manual operating area (300) includes a curved surface (300a) for the palm of the user to touch, and to operate and move the curved surface (300a) manually. The buttons (301) are assembled on the curved surface (300a), and the location of each button (301) is appropriate for the finger of the user to touch spontaneously and control the buttons (301) simultaneously. Besides, the manual operating area (300) further includes a knob (300b), installed on the curved surface (300a). As seen in FIG. 3, the knob (300b) includes a concave surface for the part of the hand between the thumb and the index finger to be close tight to and to fix with. In addition, the knob (300b) includes a hole (303) for the thumb of the hand to pass through. Since the knob (300b) is rotatably connected with the curved surface (300a), the hole (303) can moved upward (when the knob (300b) is pulled upward) and downward (when the knob (300b) is pushed downward) and the thumb is flexibly supported. In addition, the knob (300b) can be a replaceable component. The knob (300b) of different sizes can be installed to meet various needs. The relative position between the palm operating the curved surface (300a) and the fingers operating the buttons (301) are maintained whichever the multi-directive movable part (30) is operated to any angle. Hence the fingers other than the thumb can touch the buttons (301) and control them with more flexibility for the thumb is supported.

Although the present invention has been described in considerable detail with reference to certain preferred embodiments thereof, other embodiments are possible. The spirit and scope of the appended claims should no be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An operating structure of an electric pointing device, the operating structure comprising:
a multi-directive movable part, comprising a manual operating area and at least a button, the manual operating area comprising:
a curved surface, contacted and moved by a palm of a hand, wherein the buttons are installed on the curved surface, such that the locations of the buttons are easy for fingers of the hand to touch and operate the buttons accordingly; and
a knob, installed on the curved surface for leaning against a part of the hand between a thumb and an index finger;
wherein a relative position between the hand operating the curved surface and the fingers operating the buttons remains unchanged when the multi-directive movable part is moved.

2. The operating structure of claim 1, wherein the curved surface is a surface of a circle form.

3. The operating structure of claim 1, wherein the electric pointing device is a computer mouse.

4. The operating structure of claim 1, wherein the electric pointing device is a game wheel.

5. The operating structure of claim 1, wherein the knob comprises a concave portion to fit with the part of the hand between the thumb and the index finger.

6. The operating structure of claim 1, wherein an angle of a tangent plane of tops of the buttons is identical to an angle of a tangent plane of the curved surface.

7. The operating structure of claim 1, wherein the multi-directive movable part is a sphere structure.

8. The operating structure of claim 1, wherein the multi-directive movable part is a circle disk structure.

9. The operating structure of claim 1, the knob is a rotatably connected with the curved surface.

10. An operating structure of an electric pointing device, the operating structure comprising:
a multi-directive movable part, comprising a manual operating area and at least one button, the manual operating area comprising:
a curved surface, contacted and moved by a palm of a hand; and
a knob, installed on the curved surface for leaning against a part of the hand between a thumb and an index finger, wherein the at least one button is installed within an area of the curved surface where all fingers readily reach.

11. An operating structure of an electric pointing device, the operating structure comprising:
a multi-directive movable part, comprising a manual operating area and at least one button, the manual operating area comprising:
a curved surface, contacted and moved by a palm of a hand; and
a knob, installed on the curved surface, the knob having a hole for the thumb to pass through, wherein the at least one button is installed within an area of the curved surface where all fingers readily reach.

12. The operating structure of claim 11, the knob is a rotatably connected with the curved surface.
